(19) United States
(12) Patent Application Publication
(10) Pub. No.: US 2002/0119293 A1
(43) Pub. Date: Aug. 29, 2002

(54) Expandable spine recordable optical disk package

(76) Inventor: Robert Wynalda JR., Rockford, MI (US)

Correspondence Address: FRED H. ZOLLINGER, III, SAND & SEBOLT, AEGIS TOWER, 4940 MUNSUN STREET, N.W., SUITE 1100, CANTON, OH, 44718-3615, US

(21) Appl. No.: 09/794,831

(22) Filed: Feb. 28, 2001

(51) Int. Cl. B32B 3/28

(52) U.S. Cl. 428/181

(57) ABSTRACT

The invention is an expandable spine package that operates similar to a book. It contains a spine, front cover and back cover. Inside the front cover and back cover are casings that are attached to the spine of the paperboard. The spine attachment allows the casings to appear and function like pages in a book. The spine attachment also allows for additional casings to be added.

### CROSS-REFERENCE TO RELATED APPLICATIONS

### STATEMENT REGARDING FEDERALLY SPONSORED RESEARCH AND DEVELOPMENT

There was no federally sponsored research and/or development funds or other resources used to create the invention.

### REFERENCE TO SEQUENCE LISTING, A TABLE, OR A COMPUTER PROGRAM LISTING APPENDIX

Not Applicable.

### BACKGROUND

The invention of optical storage disks (as defined in “Definitions”, supra) has resulted in an explosion of marketing methods. One of the predominate benefits of disks is that manufacturers can place different forms of information and medium on the same storage method. Meaning that manufacturing and marketing people can package different products in one form.

The manufacturing and marketing persons have been using these methods of production and marketing in growing amounts. The most recent example in this area is to have numerous branch products result from one successful primary product. For example, a company that produces a successful action movie will also sell the soundtrack and videogame about the successful movie. A second use is for a software company that produces a successful program to include other programs that compliment the original program in one marketing campaign. All of these products use the same storage device—the optical storage disk. It is essential to these multiple product methods that a package be invented to accommodate the system of marketing multiple disks at one time and in one package. Robert Martin Wynalda, Jr. has invented such a package.

The package is more specifically described below in the “Description” section of the specification. As seen in the drawings and the summary, the invention claimed herein allows for the above marketing method to place multiple disks into one package. The one package allows for the disks to be viewed in a book format. It also allows for an increase in marketing/artistic space and can accommodate any number of disks. Therefore, the invention fulfills the need for an inexpensive single package to hold multiple compact disks in presentable format.

### SUMMARY

Robert Martin Wynalda, Jr. has invented the expandable disk package that allows for one or more disk casings that hold disks to be included in one package. It also allows for an increase in marketing/artwork space.

The package operates similar to a standard book with an expandable spine. It has a front cover and a back cover that open and close like a book. The front and back cover meet at the spine of the package similar to a book. However, in this invention the spine can be expanded in production to include one or more casings. Inside the front and back cover, the casing spines are attached to the spine of the package causing the casings to appear like pages in a book when opening the cover.

The package utility also allows for additional marketing/artwork space. Since the package contains a spine that connects to the disk casing spine, both sides of the front and back cover and disk casing are available for marketing/artwork.

### BRIEF DESCRIPTION OF THE DRAWINGS

FIG. 1 is a horizontal view of the package with the front and back covers laying open flat with the optical disk casing perpendicular to the front and back cover.

FIG. 2 is a horizontal view of the package with the front and back covers laying open flat with three optical disk casings perpendicular to the front and back cover.

FIG. 3 is a horizontal view of the package with the front and back covers laying open flat with one optical disk casing attached to the spine and two additional casings not attached to the spine.

FIG. 4 is a view of the package at an angle with the front and back cover closed and the spine with the casings enclosed.

FIG. 5 is a view of the package with the front and back cover open, two casings fanned and the spine.

FIG. 6 is a view of the package with the front and back cover open, three casings fanned and the spine.

FIG. 7 is a view of the inside of the package without any casings.

FIG. 8 is a view of the inside of the package without any casings.

### DETAILED DESCRIPTION OF THE DRAWINGS

Number Appendix: A consistent form of numbering identification of parts of the invention has been used for each drawing. The following is the number identification definitions:

Label “1”: plastic optical disk casing.

Label “2”: location of where the casing spine is attached to the package spine.

Label “3”: folds in the spine.

Label “4”: the spine of the package.

Label “5”: cover of the package.

Label “6”: location of casing spine adhesion to package spine.

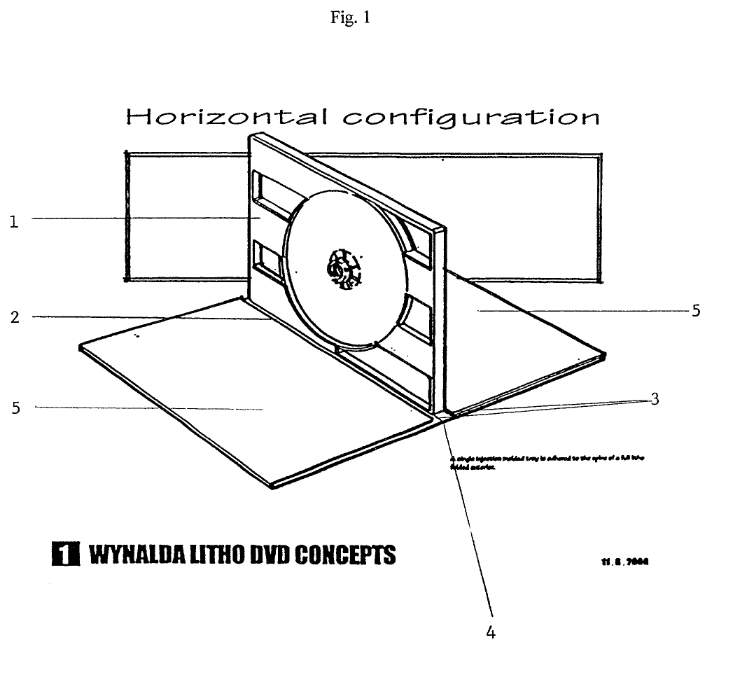

FIG. 1:

FIG. 1 shows the invention from a horizontal configuration. The package is made of a paperboard front cover (5), paperboard back cover (5) and paperboard spine (4). As the invention is shown here, it is lying with the front cover (5) and back cover (5) open, exposing the inside of the invention. The front cover (5) and back cover (5) can close so that each cover (5) is parallel with the optical disk storage casing (1). The front cover (5) and back cover (5) are not attached to the casing (1). The casing (1) is only attached at the spine (4) by an adhesive. Attaching the casing (1) at the spine (4) allows for the front cover (5) and back cover (5) on both sides to contain marketing/artwork information.

The casing (1) is shown perpendicular to the package spine (4). However, the casing (1) can fold toward the front cover (5) or back cover (5) because of the folds (3) in the spine (4). The contact point between the casing (1) and the paperboard part of the invention is the spine (4). In this diagram, the package shows one casing (1) installed. The casing (1) is attached to the package spine (4) using an adhesive.

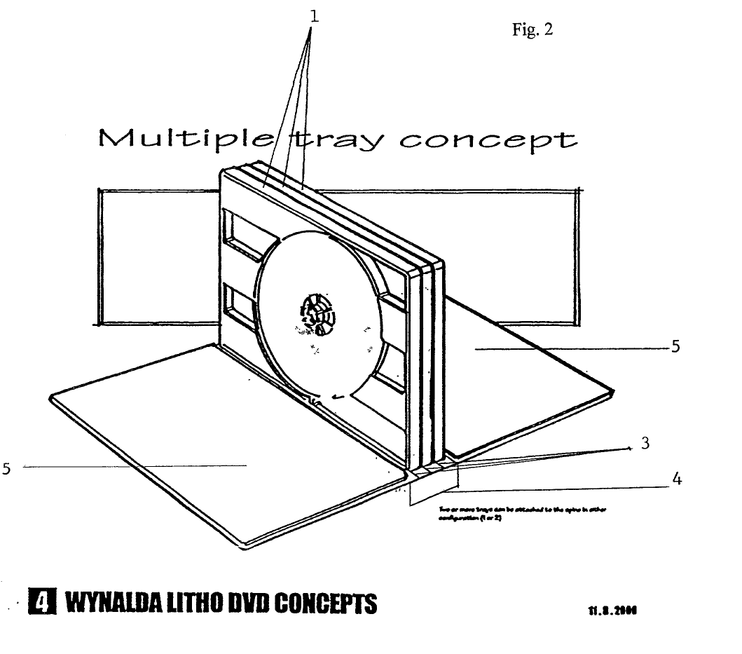

FIG. 2:

FIG. 2 shows the invention from a horizontal configuration. The package is made of a paperboard front cover (5), paperboard back cover (5) and paperboard spine (4). FIG. 2 is identical to FIG. 1 except is shows the addition of two casings (1). As the invention is shown here, it is lying with the front cover (5) and back cover (5) open, exposing the inside of the invention. The front cover (5) and back cover (5) can close so that each cover (5) is parallel with the optical disk storage casings (1). The front cover (5) and back cover (5) are not attached to the casings (1). The casings (1) are only attached at the spine (4) by an adhesive. Attaching the casing (1) at the spine (4) allows for the front cover (5) and back cover (5) on both sides to contain marketing/artwork information.

The casings (1) are shown perpendicular to the package spine (4). However, the casings (1) can fold toward the front cover (5) or back cover (5) because of the folds (3) in the spine (4). The casings (1) can also separate like the pages of a book because of the folds (3) in the spine (4) of the paperboard portion of the package.

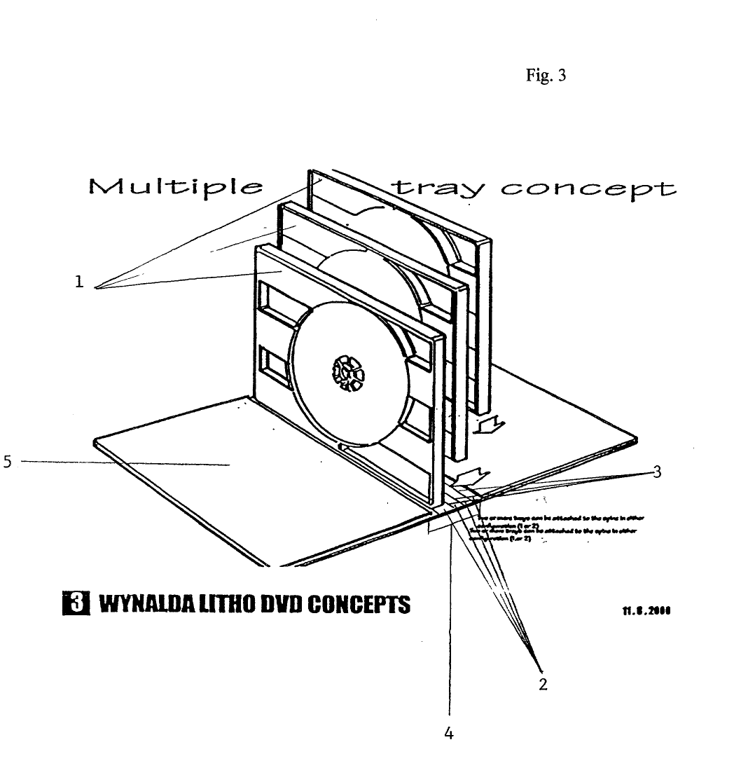

FIG. 3:

FIG. 3 shows the invention from a horizontal configuration. The package is made of a paperboard front cover (5), paperboard back cover (5) and paperboard spine (4). FIG. 3 is identical to FIG. 2 except is shows only one casing (1) attached and the remaining two casings (1) not attached. The view shows the expansion of the spine (4), the location of adhesion of the casing spine to the paperboard spine (2) and the folds (3). The remainder of the drawing is identical to FIG. 2.

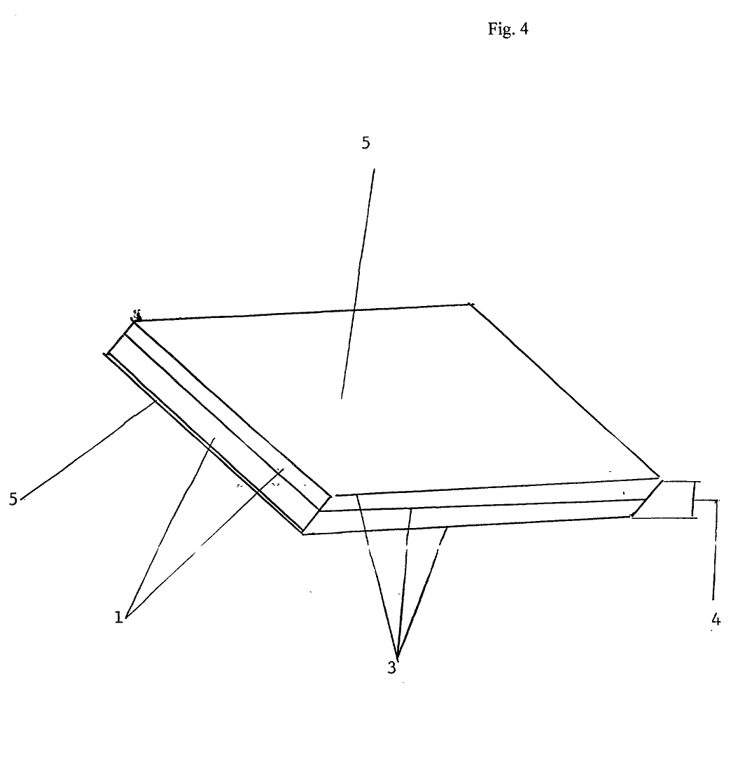

FIG. 4:

FIG. 4 shows the invention from a closed spine-facing view. In this figure the invention has the front cover (5) and back cover (5) closed. The spine (4) is exposed showing the folds (3) that allow the casings (1) to fan and the front cover (5) and back cover (5) to open. The figure also shows that the invention has the appearance of a book when closed.

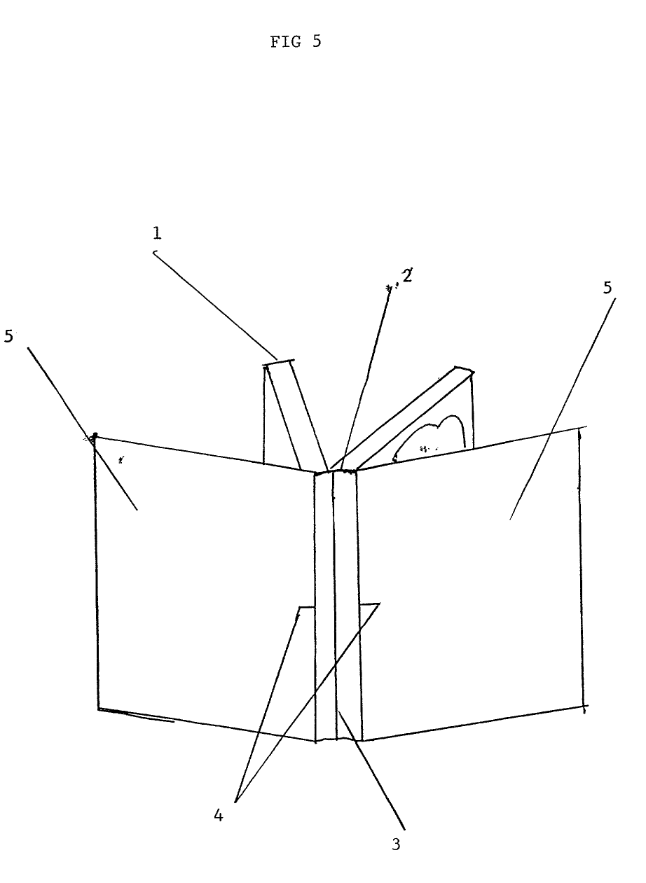

FIG. 5:

FIG. 5 shows the invention from a spine-facing view with only two casings (1). In this figure the invention has the front cover (5) and back cover (5) open. It also shows the two casings (1) fanned. The figure also shows the folds (3) in the spine (4) that allow the casings (1) to fan and the front cover (5) and back cover (5) to open.

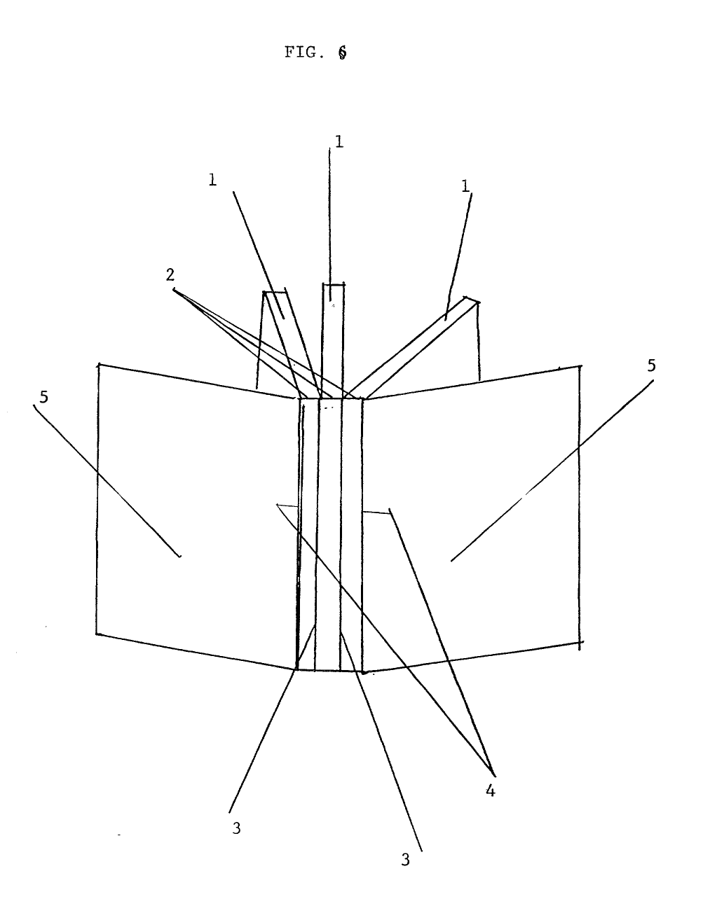

FIG. 6:

FIG. 6 also shows the invention from a spine-facing view. However, it adds a casing (1) to demonstrate the expansion of the spine (4). The spine-view also demonstrates the addition of a fold (3) to accommodate the added casing.

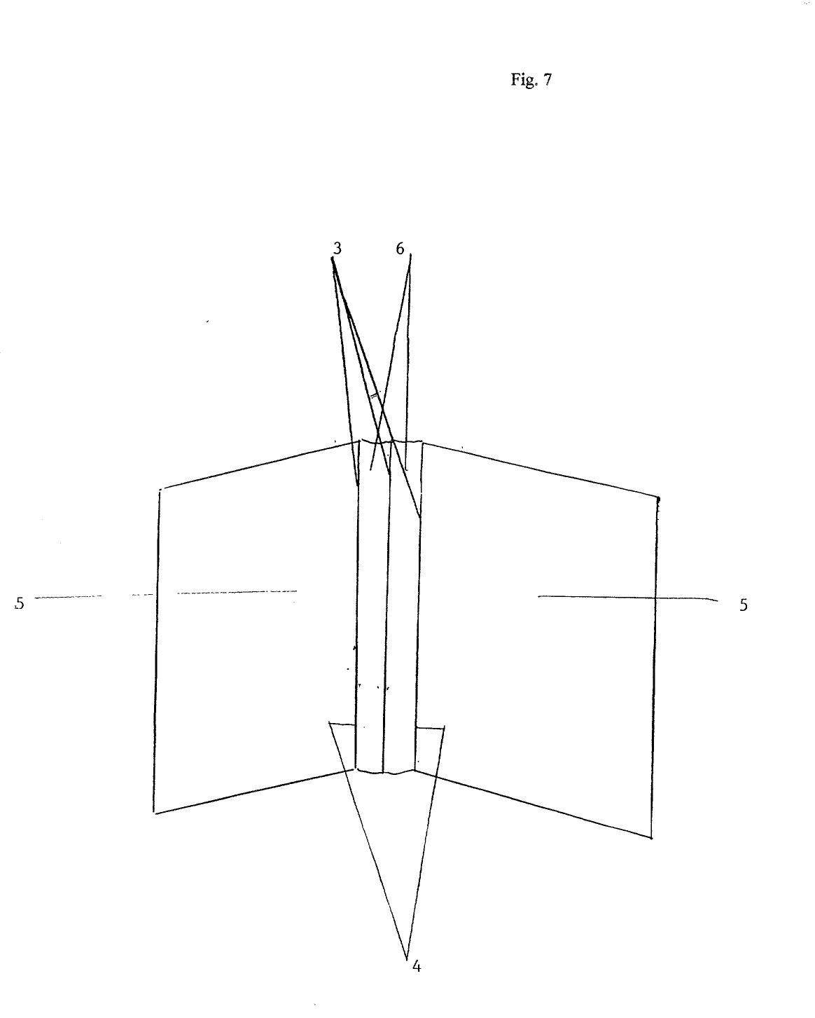

FIG. 7:

FIG. 7 shows the inside of the invention without any casings. The drawing demonstrates the paperboard portion of the invention. The front cover (5) and back cover (5) are open to expose the spine (4), the adhesion area where the casing spine and paperboard spine are attached (6), and the folds (3) in the spine that allow the casings to fan and the front cover (5) and back cover (5) to open.

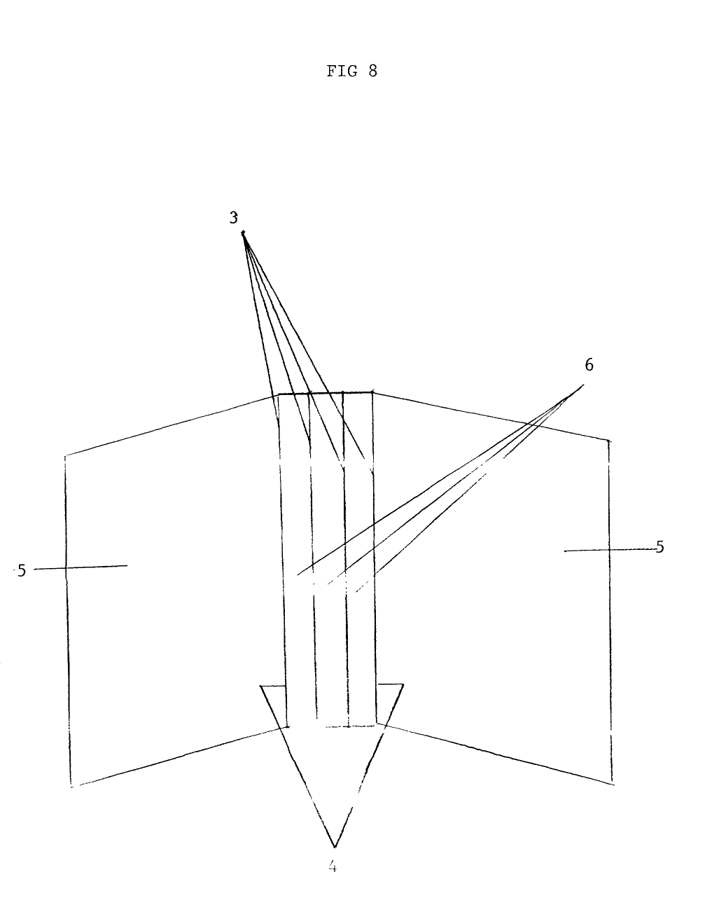

FIG. 8:

FIG. 8 shows the inside of the invention without any casings. FIG. 8 is identical to FIG. 7 except it shows an expansion of the spine (4) to accommodate additional casings. The drawing demonstrates the paperboard portion of the invention. The front cover (5) and back cover (5) are open to expose the spine (4), the adhesion area where the casing spine and paperboard spine are attached (6), and the folds (3) in the spine that allow the casings to fan and the front cover (5) and back cover (5) to open.

### DESCRIPTION

Definitions

1. Disk—an optical storage disc containing information, music, computer programs, pictures, movies or other information. An example of a disk includes, but is not limited to: Compact Disks and DVD disks.

2. Casing—a protective storage mold that holds one or more disks.

3. Spine—the binder portion of the package that is used for the adhesive connection point of the package. An example would include the binder of a book that is the connection point for the pages of the book, the front cover and the back cover.

4. Adhesion—a connection method where two separate objects are combined by a form of glue.

5. Perforations—the folds in the material that makes the spine of the package that allows the spine to bend at the folds.

Overview

As shown in FIG. 4, the Expandable Spine Optical Storage Disk Package Granting Added Marketing/Artwork Space comprises an expandable spine that connects a front cover and a back cover. The front cover and back cover open to expose casings that are attached to the expandable spine. Because the spine is expandable, the package can contain one or more casings. The appearance and functionality of the package is similar to that of a book.

Detailed Description

Robert Martin Wynalda, Jr. has created a package that allows for numerous disks to be place in one package. The package looks like a book that contains casings. The casings appear like pages in a book and function similar to pages in a book.

The package has four primary elements that create the invention. The first and primary portion of the package is the spine. The second is the folds in the spine. The third is the front cover and back cover. The fourth is the connection of the spine of the casing to the spine of the package. The combination of these elements allows for the package to open like a book and expose the casings like pages.

The front cover, back cover, and spine of the package are made of paperboard. The casing of the disk is made of plastic. The spine of the package connects the front cover and back cover. The front cover, back cover and spine are all one piece of paperboard.

The spine that connects the front and back cover is the primary element of the package. The spine is expandable. Meaning, the spine can be increased to accommodate additional casings as needed by the manufacturer. The spine is made of paperboard. The expansion comes from an increase in the paperboard size.

The spine itself has folds that run parallel with the length of the spine. The folds all run parallel with one another and the spine. The folds are lined up side by side separated by the width of a casing. The folds allow the spine to bend and the casings to separate like pages in a book.

The front cover and back cover are also important to the invention. The front and back cover act like the front and back cover of a book. The front cover and back cover are made of paperboard and allow for printing on both the front side and back side of each cover. Besides the added art and marketing allowed, the front and back cover provide enclosing and protection for the casings and disks.

The fourth aspect of the invention is the location of connection between the casing and the package. The casing and package connect to one another at the spine only. The connection location is important because it allows for the spine to expand in order to increase the number of plastic casings. It also is important because it allows the casings to be viewed like pages in a book.

How the Invention is Used

The invention is used to package optical storage disks. The optical storage disks are placed into protective casings. The protective casings are placed in the inventor's package and attached at the spine of the book and casing. The package allows for one or more casings to be included in the package. Disks are added to the package by expanding the spine during production of the package. The invention will be used to package one or more disks into a single package as illustrated.

Advantages of the Invention

The first and primary advantage of the invention is the ability for manufacturers and marketers to include one or more disks in a single package. The package can be expanded to include the single product or the multiple branch products. For example, a software company can include all of its casings/disks into one package or can package them separately. In the one package method, the casings would appear similar to the pages in a book.

A second advantage is the low production cost. Presently, the multiple casing packages are large and require a full box format. The invention package allows for inexpensive package production allowing for numerous methods of printing.

Another advantage is the alignment of one or more casings. The alignment allows for the casings to appear like pages in a book. The casings turn like pages in a book for instant access by the final user.

Yet another known advantage is that the package is the same height and width as the casings when the front cover and back cover are closed. The size of the package allows for easy transport and storage similar to the individual casings. However, the casings are now placed in an organized fashion and are protected.

an expandable spine optical disk package comprising:

1. A paperboard spine that includes:
a. folds that run the length of the spine parallel to one another;
b. a location for connection of the casing spine and the package spine between the folds;
c. the ability to expand in production to allow one or more casings.

2. A paperboard front cover that is connection to the spine of the package that operates like the front cover of a book.

3. A paperboard back cover that is connected to the spine of the package that operates like the back cover of a book.

4. A location of connection for the casing and package where the spine of the package attaches to the spine of the casing.

5. A method of presentment and storage of optical disks that function like a book.
